(19) United States
(12) Patent Application Publication
(10) Pub. No.: US 2013/0208215 A1
(43) Pub. Date: Aug. 15, 2013

(54) COLOR LIQUID CRYSTAL DISPLAY DEVICE

(71) Applicant: CHI MEI CORPORATION, (US)

(72) Inventors: Bo-Hsuan LIN, Tainan City (TW); Jung-Pin HSU, Tainan City (TW)

(73) Assignee: CHI MEI CORPORATION, Tainan City (TW)

(21) Appl. No.: 13/749,903

(22) Filed: Jan. 25, 2013

(30) Foreign Application Priority Data
Feb. 9, 2012 (TW) 101104198

(51) Int. Cl. G02F 1/1335

(52) U.S. Cl. CPC G02F 1/133621
USPC 349/71

(57) ABSTRACT

A color liquid crystal display device includes a liquid crystal display element and a backlight unit. The liquid crystal display element includes a color filter having a blue filter segment, a green filter segment, and a red filter segment. The green filter segment is prepared from a green photosensitive resin composition which includes a halogenated-phthalocyanine-based green pigment component, a yellow pigment component, an alkali-soluble resin, a compound having at least one ethylenically unsaturated group, and a photoinitiator. A weight ratio of the halogenated-phthalocyanine-based green pigment component to the yellow pigment ranges from 60/40 to 95/5. The backlight unit has a color temperature ranging from 8,000 K to 20,000 K.

### CROSS-REFERENCE TO RELATED APPLICATION

This application claims priority of Taiwanese Application No. 10110419B, filed Feb. 9, 2012.

### BACKGROUND OF THE INVENTION

1. Field of the Invention

This invention relates to a color liquid crystal display device, more particularly to a color liquid crystal display device capable of high brightness and color reproduction.

2. Description of the Related Art

Recently, liquid crystal display devices on notebook computers, digital cameras, and desktop computers have been increasingly developed due to their characteristics, such as light weight, thin profile, and power saving.

Along with enhancing technology and broadening application, large-sized liquid crystal display devices with high color reproduction, such as liquid crystal television, have been actively developed. Generally, NTSC color reproduction of desktop liquid crystal display devices ranges roughly from 50 percent to 60 percent while NTSC color reproduction of the liquid crystal television ranges roughly from 60 percent to 75 percent. This means that the liquid crystal television must have broader color reproduction.

The desktop liquid crystal display devices are usually comprised of a trichrome backlight unit and a color filter to carry out color display of the liquid crystal display devices. However, the combination is not able to satisfy the requirement of the color reproduction and the color tone for the liquid crystal television. Therefore, there are problems, such as narrow color reproduction range and low color temperature. Besides, when the trichrome backlight unit is used to manufacture liquid crystal display devices satisfying the chromaticity specified in EBU (European Broadcasting Union), the color filter must have thicker green pixel or denser pigment, which may lead to drastic decrease of light permeability and thus deteriorate display property of liquid crystal display devices. Meanwhile, color temperature of the liquid crystal color display devices is lowered, which is unable to satisfy liquid crystal television requirement.

Generally, the conventional photosensitive resin composition for forming green filter segments uses a copper-containing halogenated phthalocyanine compound as a pigment. However, the green filter segment thus obtained is unable to reach high brightness requirement. Therefore, in JP 2003-161828, zinc-containing halogenated phthalocyanine compound is disclosed to replace the conventional photosensitive resin composition.

However, when the photosensitive resin composition for forming the green filter segment uses the zinc-containing phthalocyanine compound as the pigment, high quality liquid crystal display devices are unable to be provided due to lack of sufficient light permeability in the production of a color filter of high color reproduction. Also, the zinc-containing halogenated phthalocyanine compound used along with a conventional backlight unit is unable to obtain liquid crystal display devices having satisfactory brightness and broader color reproduction. Therefore, one of the goals in the industry is to provide liquid crystal display devices with high brightness and high color reproduction so as to satisfy the current requirement.

### SUMMARY OF THE INVENTION

An object of the present invention is to provide a color liquid crystal display device having high brightness and color reproduction.

The color liquid crystal display device according to this invention includes a liquid crystal display element and a backlight unit. The liquid crystal display element includes a color filter having a blue filter segment, a green filter segment, and a red filter segment. The green filter segment is prepared from a green photosensitive resin composition which includes a pigment combination, an alkali-soluble resin, a compound having at least one ethylenically unsaturated group, and a photoinitiator. The pigment combination includes a halogenated-phthalocyanine-based green pigment compound and a yellow pigment component. A weight ratio of the halogenated-phthalocyanine-based green pigment compound to the yellow pigment component ranges from 60/40 to 95/5.

The backlight unit is coupled to the liquid crystal display element and has a color temperature ranging from 8,000 K to 20,000 K.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a preferred embodiment of a color liquid crystal display device according to this invention; and

FIG. 2 is a sectional view of a white light emitting diode used in the preferred embodiment.

### DETAILED DESCRIPTION OF THE PREFERRED EMBODIMENTS

### Green Photosensitive Resin Composition

The green filter segment is prepared from a green photosensitive resin composition which includes a pigment combination (A), an alkali-soluble resin (B), a compound having at least one ethylenically unsaturated group (C), a photoinitiator (D), and an optional organic solvent (E). The pigment combination (A) includes a halogenated-phthalocyanine-based green pigment component (A-1) and a yellow pigment component (A-2). A weight ratio of the halogenated-phthalocyanine-based green pigment component (A-1) to the yellow pigment component (A-2) ranges from 60/40 to 95/5.

When the weight ratio of the halogenated-phthalocyanine-based green pigment component (A-1) to the yellow pigment component (A-2) is less than 60/40, the color liquid crystal display device thus made has a problem of inferior color reproduction. On the other hand, when the weight ratio of the halogenated-phthalocyanine-based green pigment component (A-1) to the yellow pigment component (A-2) is higher than 95/5, the brightness of the color liquid crystal display device thus made is insufficient. The weight ratio of the halogenated-phthalocyanine-based green pigment component (A-1) to the yellow pigment component (A-2) ranges preferably from 65/35 to 90/10, and more preferably from 70/30 to 85/15.

Preferably, a total amount of the halogenated-phthalocyanine-based green pigment component (A-1) and the yellow pigment component (A-2) is at least 80 wt % based on 100 wt % of the pigment combination (A). When the total amount of the halogenated-phthalocyanine-based green pigment component (A-1) and the yellow pigment component (A-2) is at least 80 wt %, the color liquid crystal display device thus made has better brightness and high color reproduction.

The following is a detailed description of the pigment combination (A), the alkali-soluble resin (B), the compound having at least one ethylenically unsaturated group (C), the photoinitiator (D), and the organic solvent (B).

### Pigment Combination (A)

The pigment combination (A) includes the halogenated-phthalocyanine-based green pigment component (A-1) and the yellow pigment component (A-2).

Preferably, the halogenated-phthalocyanine-based green pigment component (A-1) is selected from C.I. Pigment Green 07, C.I. Pigment Green 36, C.I. Pigment Green 37, C.I. Pigment Green 42, C.I. Pigment Green 58, or combinations thereof. More preferably, the halogenated-phthalocyanine-based green pigment component (A-1) is selected from C.I. Pigment Green 07, C.I. Pigment Green 36, C.I. Pigment Green 58, or combinations thereof.

Preferably, a total amount of C.I. Pigment Green 07, C.I. Pigment Green 36, and C.I. Pigment Green 58 is at least 80 wt % based on 100 wt % of the halogenated-phthalocyanine-based green pigment component (A-1). When the total amount of C.I. Pigment Green 07, C.I. Pigment Green 36, and C.I. Pigment Green 58 is at least 80 wt %, the color liquid crystal display device thus made has high color reproduction.

Preferably, the yellow pigment component (A-2) is selected from C.I. Pigment Yellow 1, C.I. Pigment Yellow 3, C.I. Pigment Yellow 10, C.I. Pigment Yellow 12, C.I. Pigment Yellow 13, C.I. Pigment Yellow 14, C.I. Pigment Yellow 17, C.I. Pigment Yellow 20, C.I. Pigment Yellow 24, C.I. Pigment Yellow 31, C.I. Pigment Yellow 55, C.I. Pigment Yellow 81, C.I. Pigment Yellow 83, C.I. Pigment Yellow 93, C.I. Pigment Yellow 94, C.I. Pigment Yellow 97, C.I. Pigment Yellow 109, C.I. Pigment Yellow 110, C.I. Pigment Yellow 128, C.I. Pigment Yellow 138, C.I. Pigment Yellow 139, C.I. Pigment Yellow 150, C.I. Pigment Yellow 153, C.I. Pigment Yellow 154, C.I. Pigment Yellow 155, C.I. Pigment Yellow 166, C.I. Pigment Yellow 167, C.I. Pigment Yellow 168, C.I. Pigment Yellow 180, C.I. Pigment Yellow 185, C.I. Pigment Yellow 211, C.I. Pigment Yellow 219, or combinations thereof. More preferably, the yellow pigment component (A-2) is selected from C.I. Pigment Yellow 138, C.I. Pigment Yellow 139, C.I. Pigment Yellow 150, or combinations thereof.

Preferably, a total amount of C.I. Pigment Yellow 1.38, C.I. Pigment Yellow 139, and C.I. Yellow 150 is at least 20 wt % based on 100 wt % of the yellow pigment component (A-2). When the total amount of C.I. Pigment Yellow 138, C.I. Pigment Yellow 139, and C.I. Yellow 150 is at least 20 wt %, the color liquid crystal display device thus made has better brightness.

Preferably, the pigment combination (A) further includes an orange pigment component (A-3).

Preferably, the orange pigment component (A-3) is selected from C.I. Pigment Orange 13, C.I. Pigment Orange 36, C.I. Pigment Orange 43, C.I. Pigment Orange 51, C.I. Pigment Orange 61, C.I. Pigment Orange 71, or combinations thereof.

Preferably, the pigment combination (A) is used in an amount ranging from 20 to 200 parts by weight, based on 100 parts by weight of the alkali-soluble resin (B).

### <Alkali-Soluble Resin (B)

The alkali-soluble resin (B) is obtained by subjecting an ethylenically unsaturated monomer having one or more carboxyl groups and another copolymerizable ethylenically unsaturated monomer to conduct a copolymerization. Preferably, the amounts of the ethylenically unsaturated monomer having one or more carboxyl groups and the another copolymerizable ethylenically unsaturated monomer used in the copolymerization reaction are 50-95 wt % and 5-50 wt %, respectively.

Examples of the ethylenically unsaturated monomer having one or more carboxyl groups can be used alone or in admixture of two or more thereof, and include, but are not limited to, unsaturated monocarboxylic acids, such as acrylic acid, methacrylic acid, butenoic acid, α-chloroacrylic acid, ethacrylic acid, cinnamic acid, 2-acryloylethoxy succinate, 2-methacryloylethoxy succinate, or the like; unsaturated dicarboxylic acids and/or anhydrides thereof, such as maleic acid, maleic anhydride, fumaric acid, itaconic acid, itaconic anhydride, citraconic acid, citraconic anhydride, or the like; and unsaturated polycarboxylic acids having at least three carboxyl groups in the molecules and/or anhydrides thereof. Preferably, the ethylenically unsaturated monomer having one or more carboxyl groups is selected from acrylic acid, methacrylic acid, 2-acryloylethoxy succinate, or 2-methacryloylethoxy succinate. More preferably, the ethylenically unsaturated monomer having one or more carboxyl groups is selected from 2-acryloylethoxy succinate or 2-methacryloylethoxy succinate. The ethylenically unsaturated monomer having one or more carboxyl groups is used for increasing the pigment dispersion, enhancing the development speed, and reducing the residue.

Examples of the another copolymeriable ethylenically unsaturated monomer can be used alone or in admixture of two or more thereof, and include, but are not limited to, vinyl aromatic compounds, such as styrene, α-methyl styrene, vinyl toluene, p-chlorostyrene, methoxystyrene, or the like; maleimides, such as N-phenylmaleimide, N-o-hydroxyphenyl maleimide, N-m-hydroxyphenylmaleimide, N-p-hydroxyphenylmaleimide, N-o-methylphenylmaleimide, N-m-methylphenylmaleimide, N-p-methylphenylmaleimide, N-o-methoxyphenylmaleimide, N-m-methoxyphenylmaleimide, N-p-methoxyphenylmaleimide, N-cyclohexylmaleimide, or the like; unsaturated carboxylates, such as methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, iso-butyl acrylate, iso-butyl methacrylate, sec-butyl acrylate, sec-butyl methacrylate, tert-butyl acrylate, tert-butyl methacrylate, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 2-hydroxybutyl acrylate, 2-hydroxybutyl methacrylate, 3-hydroxybutyl acrylate, 3-hydroxybutyl methacrylate, 4-hydroxybutyl acrylate, 4-hydroxybutyl methacrylate, allyl acrylate, allyl methacrylate, benzyl acrylate, benzyl methacrylate, phenyl acrylate, phenyl methacrylate, methoxy triethylene glycol acrylate, methoxy triethylene glycol methacrylate, lauryl methacrylate, tetradecyl methacrylate, cetyl methacrylate, octadecyl methacrylate, eicosyl methacrylate, docosyl methacrylate, dicyclopentenyloxyethyl acrylate, or the like; N,N-dimethyl aminoethyl acrylate, N,N-dimethyl aminoethyl methacrylate, N,N-diethyl aminopropyl acrylate, N,N-dimethyl aminopropyl methacrylate, N,N-dibutyl aminopropyl acrylate, isobutylaminoethyl N-methylacrylate, or the like; unsaturated glycidyl carboxylates, such as glycidyl acrylate, glycidyl methacrylate, or the like; vinyl carboxylates, such as vinyl acetate, vinyl propionate, vinyl butyrate, or the like; unsaturated ethers, such as vinyl methyl ether, vinyl ethyl ether, allyl glycidyl ether, methallyl glycidyl ether, or the like; vinyl cyanides, such as acrylonitrile, methyl acrylonitrile, α-chloroacrylonitrile, vinylidene cyanide, or the like; unsaturated amides, such as acrylamide, methacrylamide, α-chloroacrylamide, N-hydroxyethyl acrylamide, N-hydroxyethyl methacrylamide, or the like; and aliphatic conjugate dienes, such as 1,3-butadiene, isoprene, chloroprene, or the like.

Preferably, the another copolymerizable ethylenically unsaturated monomer is selected from styrene, N-phenylmaleimide, methyl acrylate, methyl methacrylate, 2-hydroxyethyl acrylate, 2-hydroxyethyl methacrylate, benzyl acrylate, benzyl methacrylate, dicyclopentenyloxyethyl acrylate, or combinations thereof.

Examples of the solvent suitable for preparing the alkali-soluble resin (B) can be used alone or in admixture of two or more thereof, and include, but are not limited to, (poly)alkylene glycol monoalkyl ethers, such as ethylene glycol methyl ether, ethylene glycol ethyl ether, diethylene glycol methyl ether, diethylene glycol ethyl ether, diethylene glycol n-propyl ether, diethylene glycol n-butyl ether, triethylene glycol methyl ether, triethylene glycol ethyl ether, propylene glycol methyl ether, propylene glycol ethyl ether, dipropylene glycol methyl ether, dipropylene glycol ethyl ether, dipropylene glycol n-propyl ether, dipropylene glycol n-butyl ether, tripropylene glycol methyl ether, tripropylene glycol ethyl ether, or the like; (poly)alkylene glycol monoalkyl ether acetates, such as ethylene glycol methyl ether acetate, ethylene glycol ethyl ether acetate, propylene glycol methyl ether acetate, propylene glycol ethyl ether acetate, or the like; other ethers, such as diethylene glycol dimethyl ether, diethylene glycol methyl ethyl ether, diethylene glycol diethyl ether, tetrahydrofuran, or the like; ketones, such as methyl ethyl ketone, cyclohexanone, 2-heptanone, 3-heptanone, or the like; alkyl lactate, such as methyl 2-hydroxypropionate, ethyl 2-hydroxypropionate, or the like; other esters, such as methyl 2-hydroxy-2-methylproprionate, ethyl 2-hydroxy-2-methylpropionate, methyl 3-methoxypropionate, ethyl 3-methoxypropionate, methyl 3-ethoxypropionate, ethyl 3-ethoxypropionate, ethyl ethoxy acetate, ethyl hydroxy acetate, methyl 2-hydroxy-3-methylbutyrate, 3-methyl-3-methoxybutyl acetate, 3-methyl-3-methoxybutyl propionate, ethyl acetate, n-propyl acetate, iso-propyl acetate, n-butyl acetate, iso-butyl acetate, n-amyl acetate, iso-amyl acetate, n-butyl propionate, ethyl butyrate, n-propyl butyrate, iso-propyl butyrate, n-butyl butyrate, methyl pyruvate, ethyl pyruvate, n-propyl pyruvate, methyl acetoacetate, ethyl acetoacetate, ethyl 2-methoxybutyrate, or the like; aromatic hydrocarbons, such as toluene, xylene, or the like; and carboxylic acid amide, such as N-methyl-2-pyrrolidone, N,N-dimethylformamide, N,N-dimethylacetamide, or the like. Preferably, the solvent is selected from propylene glycol methyl ether acetate, ethyl 3-ethoxypropionate, or a combination thereof. The (poly)alkylene glycol monoalkyl ethers include alkylene glycol monoalkyl ethers and polyalkylene glycol monoalkyl ethers. The (poly)alkylene glycol monoalkyl ether acetates include alkylene glycol monoalkyl ether acetates and polyalkylene glycol monoalkyl ether acetates.

The initiator used for preparing the alkali-soluble resin (B) is a free radical polymerization initiator, examples of which include, but are not limited to, azo compounds, such as 2,2′-azobisisobutyronitrile, 2,2′-azobis-(2,4-dimethylvaleronitrile), 2,2′-azobis-(4-methoxy-2,4-dimethylvaleronitrile), 2,2′-azobis-2-methylbutyronitrile, or the like; and peroxides, such as benzoyl peroxide, or the like.

### Compound Having at Least one Ethylenically Unsaturated Group (C)

The compound having at least one ethylenically unsaturated group (C) used in the present invention is a compound having one or more ethylenically unsaturated groups.

Examples of the compound having one ethylenically unsaturated group can be used alone or in admixture of two or more thereof, and include, but are not limited to, acrylamide, acryloylmorpholine, methylacryloylmorpholine, 7-amino-3,7-dimethyloctyl acrylate, 7-amino-3,7-dimethyloctyl methylacrylate, iso-butoxymethyl acrylamide, iso-butoxymethyl methylacrylamide, iso-bornyloxyethyl acrylate, iso-bornyloxyethyl methylacrylate, iso-bornyl acrylate, iso-bornyl methylacrylate, 2-ethylhexyl acrylate, 2-methylacrylate, ethyl diethylene glycol acrylate, ethyldiethylene glycol methylacrylate, t-octyl acrylamide, t-octyl methylacrylamide, diacetone acrylamide, diacetone methylacrylamide, dimethylaminoethyl acrylate, dimethylaminoethyl methylacrylate, dodecyl acrylate, dodecyl methylacrylate, dicyclopentenyloxyethyl acrylate, dicyclopentenyloxyethyl methylacrylate, dicyclopentenyl acrylate, dicyclopentenyl methylacrylate, N,N-dimethyl acrylamide, N,N-dimethyl methylacrylamide, tetrachlorophenyl acrylate, tetrachlorophenyl methylacrylate, 2-tetrachlorophenoxy ethyl acrylate, 2-tetrachlorophenoxy ethyl methylacrylate, tetrahydrofurfuryl acrylate, tetrahydrofurfuryl methylacrylate, tetrabromophenyl acrylate, tetrabromophenyl methylacrylate, 2-tetrabromophenoxyethyl acrylate, 2-tetrabromophenoxyethyl methylacrylate, 2-trichlorophenoxyethyl acrylate, 2-trichlorophenoxyethyl methylacrylate, tribromophenyl acrylate, tribromophenyl methylacrylate, 2-tribromophenoxyethyl acrylate, 2-tribromophenoxyethyl methylacrylate, 2-hydroxyethyl acrylate, 2-hydroxyethyl methacrylate, 2-hydroxypropyl acrylate, 2-hydroxypropyl methylacrylate, vinylcaprolactam, N-vinylpyrrolidone, phenoxyethyl acrylate, phenoxyethyl methylacrylate, pentachlorophenyl acrylate, pentachlorophenyl methylacrylate, pentabromophenyl acrylate, pentabromophenyl methylacrylate, polyethylene glycol monoacrylate, polyethylene glycol monomethylacrylate, polypropylene glycol monoacrylate, polypropylene glycol monomethylacrylate, bornyl acrylate, and bornyl methylacrylate.

Examples of the compound having two or more ethylenically unsaturated groups can be used alone or in admixture of two or more thereof, and include, but are not limited to, ethylene glycol diacrylate, ethylene glycol dimethylacrylate, dicyclopentenyl diacrylate, dicyclopentenyl dimethylacrylate, triethylene glycol diacrylate, tetraethylene glycol diacrylate, tetraethylene glycol dimethylacrylate, tri(2-hydroxyethyl) isocyanate diacrylate, tri(2-hydroxyethyl) isocyanate dimethylacrylate, tri(2-hydroxyethyl) isocyanate triacrylate, tri(2-hydroxyethyl) isocyanate trimethylacrylate, caprolactone-modified tri(2-hydroxyethyl) isocyanate triacrylate, caprolactone-modified tri (2-hydroxyethyl) isocyanate trimethylacrylate, trimethylolpropyl triacrylate, trimethylolpropyl trimethylacrylate, ethylene oxide (hereinafter abbreviated as EO) modified trimethylolpropyl triacrylate, EO-modified trimethylolpropyl trimethylacrylate, propylene oxide (hereinafter abbreviated as PO) modified trimethylolpropyl triacrylate, PO-modified trimethylolpropyl trimethylacrylate, tripropylene glycol diacrylate, tripropylene glycol dimethylacrylate, neo-pentyl glycol diacrylate, neo-pentyl glycol dimethylacrylate, 1,4-butanediol diacrylate, 1,4-butanediol dimethylacrylate, 1,6-hexanediol diacrylate, 1,6-hexanediol dimethylacrylate, pentaerythritol triacrylate, pentaerythritol trimethylacrylate, pentaerythritol tetraacrylate, pentaerythritol tetramethylacrylate, polyester diacrylate polyester dimethylacrylate, polyethylene glycol diacrylate, polyethylene glycol dimethylacrylate, dipentaerythritol hexaacrylate, dipentaerythritol hexamethylacrylate, dipentaerythritol pentaacrylate, dipentaerythritol pentamethylacrylate, dipentaerythritol tetraacrylate, dipentaerythritol tetramethylacrylate, caprolactone-modified dipentaerythritol hexaacrylate, caprolactone-modified dipentaerythritol hexamethylacrylate, caprolactone-modified dipentaerythritol pentaacrylate, caprolactone-modified dipentaerythritol pentamethylacrylate, ditrimethylolpropyl tetraacrylate, ditrimethylolpropyl tetramethylacrylate, EO-modified bisphenol A diacrylate, EO-modified bisphenol A dimethylacrylate, PO-modified bisphenol A diacrylate, PO-modified bisphenol A dimethylacrylate, EO-modified hydrogenated bisphenol A diacrylate, EO-modified hydrogenated bisphenol A dimethylacrylate, PO-modified hydrogenated bisphenol A diacrylate, PO-modified hydrogenated bisphenol A dimethylacrylate, PO-modified glycerol triacrylate, EO-modified bisphenol Fdiacrylate, EO-modified bisphenol F dimethylacrylate, phenol novolac polyglycidyl ether acrylate, and phenol novolac polyglycidyl ether methylacrylate.

Preferably, the compound having at least one ethylenically unsaturated group (C) is selected from trimethylolpropyl triacrylate, EO-modified trimethylolpropyl triacrylate, PO-modified trimethylolpropyl triacrylate, pentaerythritol triacrylate, pentaerythritol tetraacrylate, dipentaerythritol hexaacrylate, dipentaerythritol pentaacrylate, dipentaerythritol tetraacrylate, caprolactone-modified dipentaerythritol hexaacrylate, ditrimethylolpropyl tetraacrylate, PO-modified glycerol triacrylate, or combinations thereof.

Preferably, the compound having at least one ethylenically unsaturated group (C) is used in an amount ranging from 20 to 200 parts by weight, based on 100 parts by weight of the alkali-soluble resin (B).

### Photoinitiator (D)

Examples of the photoinitiator (D) can be used alone or in admixture of two or more thereof, and include, but are not limited to, O-acyloxime compounds, triazine compounds, acetophenone compounds, biimidazole compounds, and benzophenone compounds. Preferably, the photoinitiator (D) is used in amount ranging from 10 to 50 parts by weight, based on 100 parts by weight of the alkali-soluble resin (B).

Examples of the O-acyloxime compounds can be used alone or in admixture of two or more thereof, and include, but are not limited to, 1-[4-(phenylthio)phenyl]-heptane-1,2-dione 2-(O-benzoyloxime), 1-[4-(phenylthio)phenyl]-octane-1,2-dione 2-(O-benzoyloxime), 1-[4-(benzoyl)phenyl]-heptane-1,2-dione 2-(O-benzoyloxime), 1-[9-ethyl-6-(2-methylbenzoyl)-9H-carbazol-3-yl]-ethylketo 1-(O-acetyloxime), 1-[9-ethyl-6-(3-methylbenzoyl)-9H-carbazol-3-yl]-ethylketo 1-(O-acetyloxime), 1-[9-ethyl-1-6-benzoyl-9H-carbazol-3-yl]-ethylketo 1-(O-acetyloxime), ethylketo-1-[9-ethyl-6-(2-methyl-4-tetrahydrofurylbenzoyl)-9H-carbazol-3-yl]-1-(O-acetyloxime), ethylketo-1-[9-ethyl-6-(2-methyl-5-tetrahydropyranylbenzoyl)-9H-carbazol-3-yl]-1-(O-acetyloxime), ethylketo-1-[9-ethyl-6-(2-methyl-4-tetrahydrofurylmethoxybenzoyl)-9H-carbazol)-3-yl]-1-(O-acetyloxime), ethylketo-1-[9-ethyl-6-(2-methyl-5-tetrahydrofurylmethoxybenzoyl)-9H-carbazol-3-yl]-1-(O-acetyloxime), ethylketo-1-[9-ethyl-6-{2-methyl-4-(2,2-dimethyl-1,3-dioxolyl)benzoyl}-9H-carbazol-3-yl]-1-(O-acetyloxime), and ethylketo-1-[9-ethyl-6-{2-methyl-4-(2,2-bimethyl-1,3-dioxolyl)methoxybenzoyl}-9H-carbazol-3-yl]-1-(O-acetyloxime).

Examples of the triazine compounds can be used alone or in admixture of two or more thereof, and include, but are not limited to, 2,4-bis(trichloromethyl)-6-(p-methoxy)styryl-s-triazine, 2,4-bis(trichloromethyl)-6-(1-p-dimethylaminophenyl-1,3-butadienyl)-s-triazine, and 2-trichloromethyl-4-amino-6-(p-methoxy)styryl-s-triazine.

Examples of the acetophenone compounds can be used alone or in admixture of two or more thereof, and include, but are not limited to, p-dimethylaminoacetophenone, α,α′-dimethoxyazoxyacetophenone, 2,2′-dimethyl-2-phenylacetophenone, p-methoxyacetophenone, 2-methyl-1-(4-methylthiophenyl)-2-morpholino-1-propan one, and 2-benzyl-2-N,N-dimethylamino-1-(4-morpholinophenyl)-1-butanone.

Examples of the biimidazole compounds can be used alone or in admixture of two or more thereof, and include, but are not limited to, 2,2′-bis(o-chlorophenyl)-4,4′,5,5′-tetraphenylbiimidazole, 2,2′-bis(o-fluorophenyl-4,4′,5,5′-tetraphenylbiimidazole, 2,2′-bis(o-methylphenyl)-4,4′,5,5′-tetraphenylbiimidazole, 2,2′-bis(o-methoxyphenyl)-4,4′,5,5′-tetraphenylbiimidazole, 2,2′-bis(o-ethylphenyl)-4,4′,5,5′-tetraphenylbiimidazole, 2,2′-bis(p-methoxyphenyl)-4,4′,5,5′-tetraphenylbiimidazole, 2,2′-bis(2,2′,4,4′-tetramethoxyphenyl)-4,4′,5,5′-tetraphenylbiimidazole, 2,2′-bis(2-chlorophenyl)-4,4′,5,5′-tetraphenylbiimidazole, and 2,2′-bis(2,4-dichlorophenyl)-4,4′,5,5′-tetraphenylbiimidazole.

Examples of the benzophenone compounds can be used alone or in admixture of two or more thereof, and include, but are not limited to, thioxanthone, 2,4-diethylthioxanthone, thioxanthone-4-sulfone, benzophenone, 4,4′-bis(dimethylamino)benzophenone, and 4,4′-bis(diethylamino)benzophenone.

Preferably, the photoinitiator (D) is selected from 1-[4-(phenylthio)phenyl]-octane-1,2-dione 2-(O-benzoyloxime), 1-[9-ethyl-6-(2-methylbenzoyl)-9H-carbazol-3-yl]-ethylketo 1-(O-acetyloxime), ethylketo-1-[9-ethyl-6-{2-methyl-4-tetrahydrofurylmethoxybenzoyl}-9H-carbazol-3-yl]-1-(O-acetyloxime), ethylketo-1-[9-ethyl-6-{2-methyl-4-(2,2-dimethyl-1,3-dioxolyl)methoxybenzoyl}-9H-carbazol-3-yl]-1-(O-acetyloxime), 2,4-bis(trichloromethyl)-6-(p-methoxy)styryl-s-triazine, 2-benzyl-2-N,N-dimethylamino-1-(4-morpholinophenyl)-1-butanone, 2,2′-bis(2,4-dichlorophenyl)-4,4′,5,5′-tetraphenylbiimidazole, 4,4′-bis(diethyl amino)benzophenone, or combinations thereof.

In addition to the aforesaid photoinitiators (D), other initiators can be further added into the green photosensitive resin composition of the present invention provided that the physical properties are not affected. Examples of the other initiators include α-diketone compounds, acyloin compounds, acyloin ether compounds, acylphosphineoxide compounds, quinine compounds, halide compounds, peroxide compounds, or the like.

Examples of the α-diketone compounds can be used alone or in admixture of two or more thereof, and include, but are not limited to, benzil and acetyl compounds.

Examples of the acyloin compounds can be used alone or in admixture of two or more thereof, and one of the examples thereof is benzoin.

Examples of the acyloin ether compounds can be used alone or in admixture of two or more thereof, and include, but are limited to, benzoin methylether, benzoin ethylether, and benzoin isopropyl ether.

Examples of the acylphosphine oxide compounds can be used alone or in admixture of two or more thereof, and include, but are not limited to, 2, 4, 6-trimethylbenzoyl diphenylphosphine oxide, and bis-(2,6-dimethoxybenzoyl)-2,4,4 -trimethylbenzyl phosphine oxide.

Examples of the quinone compounds can be used alone or in admixture of two or more thereof, and include, but are not limited to, anthraquinone and 1,4-naphthoquinone.

Examples of the halide compounds can be used alone or in admixture of two or more thereof, and include, but are not limited to, phenacyl chloride, tribromomethyl phenylsulfone, and tris(trichloromethyl)-s-triazine.

Examples of the peroxide compounds can be used alone or in admixture of two or more thereof, and one of the examples thereof is di-tert-butyl peroxide.

### Organic Solvent (E)

The green photosensitive resin composition in this invention is prepared by dissolving all the above components other than the pigment combination (A) in the organic solvent (E) to prepare a liquid composition followed by homogeneously mixing the liquid composition with the pigment combination (A). The organic solvent (E) must be able to dissolve the alkali-soluble resin (B), the compound having at least one ethylenically unsaturated group (C), and the photoinitiator (D). Also, the organic solvent (E) must not be able to react with the components dissolved therein, and has proper volatility. The organic solvent (E) is used in an amount ranging from 500 to 3,000 parts by weight, based on 100 parts by weight of the alkali-soluble resin (B).

The organic solvent (E) suitable for preparing the green photosensitive resin composition can be selected from the examples of the solvent for preparing the alkali-soluble resin (B). Preferably, the organic solvent (E) suitable for preparing the green photosensitive resin composition is selected from propylene glycol methyl ether acetate or ethyl 3-ethoxypropionate.

### Functional Additives (F)

The green photosensitive resin composition in the present invention can contain other functional additives (F), such as fillers, polymers other than the alkali-soluble resin (B), adhesion-promoting agents, antioxidants, UV absorbents, anti-coagulants, or the like so as to provide the green filter segment made from the green photosensitive resin composition with specifically required physical and chemical properties. The aforesaid examples of the functional additives (F) can be used alone or in admixture of two or more thereof.

Examples of the fillers include glass, aluminum, or the like. Examples of the polymers other than the alkali-soluble resin (B) include polyvinyl alcohol, polyethylene glycol monoalkyl ether, polyfluoro alkyl acrylate, or the like. Examples of the adhesion-promoting agents include vinyl trimethoxysilane, vinyltriethoxysilane, vinyltris(2-methoxyethoxy)silane N-(2-aminoethyl)-3-aminopropylmethyldimethoxysilane, N-(2-aminoethyl)-3-aminopropyltrimethoxysilane, 3-aminopropyltriethoxysilane, 3-glycidyloxypropyltrimethoxysilane, 3-glycidyloxypropylmethyldimethoxysilane, 2-(3,4-epoxycyclohexyl)ethyltrimethoxysilane, 3-chloropropylmethyldimethoxysilane,

3-chloropropyltrimethoxysilane, 3-methacryloxypropyltrimethoxysilane, 3-mercaptopropyltrimethoxysilane, or the like. Examples of the antioxidants include 2,2-thiobis(4-methyl-6-t-butylphenol), 2,6-di-t-butylphenol, or the like. Examples of the UV absorbents include 2-(3-t-butyl-5-methyl-2-hydroxyphenyl)-5-chlorobenzotriazole, alkoxybenzophenone, or the like. Examples of the anti-coagulants include sodium polyacrylate, or the like.

### Red Photosensitive Resin Composition

The red filter segment in the present invention can be made of a conventional red photosensitive resin composition. In this example, the components of the red photosensitive resin composition are substantially identical to those of the green photosensitive resin composition except that instead of the pigment combination (A) used in the green photosensitive resin composition, a red pigment combination is used in the red photosensitive resin composition.

The red pigment combination includes a first red pigment component having an azo condensation structure and a second red pigment component having an anthraquinone structure, or a combination thereof. Examples of the first red pigment component can be used alone or in admixture of two or more thereof, and include, but are not limited to, C.I. Pigment Red 83, C.I. Pigment Red 89, and C.I. Pigment Red 177. Preferably, the first red pigment Component is selected from C.I. Pigment Red 89, C.I. Pigment Red 177, or a combination thereof.

Examples of the second red pigment component can be used alone or in admixture of two or more thereof, and include, but are not limited to, C.I. Pigment Red 144, C.I. Pigment Red 166, C.I. Pigment Red 214, C.I. Pigment Red 220, C.I. Pigment Red 221, C.I. Pigment Red 242, C.I. Pigment Red 248, and C.I. Pigment Red 262. Preferably, the second red pigment component is selected from C.I. Pigment Red 166, C.I. Pigment Red 242, or a combination thereof.

In order to adjust chromaticity, the red pigment combination can further include a third red pigment component and a yellow pigment component. Preferably, the third red pigment component is selected from quinacridone pigments, perylene pigments, pyranthrene-8,16-dione pigments, or combinations thereof. Preferably, the yellow pigment component is selected from isoindole pigments, quinophthalone pigments, azo pigments, or combinations thereof. More preferably, the yellow pigment component is a guinophthalone pigment. Examples of the yellow pigment component used in the red pigment combination can be identical to the examples of the yellow pigment component (A-2) used in the pigment combination (A). In view of color purity and transparency, the yellow pigment component is preferably selected from C.I. Pigment Yellow 83, C.I. Pigment Yellow 138, C.I. Pigment Yellow 139, C.I. Pigment Yellow 150, C.I. Pigment Yellow 185, C.I. Pigment Yellow 219, or combinations thereof.

### Blue Photosensitive Resin Composition

The blue filter segment in the present invention can be made of a conventional blue photosensitive resin composition. In this example, the components of the blue photosensitive resin composition are substantially identical to those of the green photosensitive resin composition except that instead of the pigment combination (A) used in the green photosensitive resin composition, a blue pigment combination is used in the blue photosensitive resin composition. The blue pigment combination includes a blue pigment component.

Examples of the blue pigment component can be used alone or in admixture of two or more thereof, and include, but are not limited to, C.I. Pigment Blue 6, C.I. Pigment Blue 15:1, C.I. Pigment Blue 15:2, C.I. Pigment Blue 15:3, C.I. Pigment Blue 15:4, C.I. Pigment Blue 15:5, C.I. Pigment Blue 15:6, C.I. Pigment Blue 21, C.I. Pigment Blue 22, C.I. Pigment Blue 28, C.I. Pigment Blue 60, and C.I. Pigment Blue 64.

Preferably, the blue pigment combination further includes a violet pigment component. Examples of the violet pigment component can be used alone or in admixture of two or more thereof, and include, but are not limited to, C.I. Pigment Violet 14, C.I. Pigment Violet 19, C.I. Pigment Violet 23, C.I. Pigment Violet 29, C.I. Pigment Violet 32, C.I. Pigment Violet 33, C.I. Pigment Violet 36, C.I. Pigment Violet 37, C.I. Pigment Violet 38, C.I. Pigment violet 40, and C.I. Pigment Violet 50.

In order to adjust chromaticity, the blue pigment combination further includes a green pigment component. The green pigment component is identical to the halogenated-phthalocyanine-based green pigment compound (A-1) included in the green photosensitive resin composition. Preferably, the green pigment component is selected from C.I. Pigment Green 7, C.I. Pigment Green 36, C.I. Pigment Green 58, or combinations thereof.

### Color Filter

The green, photosensitive resin composition in a liquid state for the color filter in the present invention can be formed by blending the alkali-soluble resin (B), the compound having at least one ethylenically unsaturated group) (C), and the photoinitiator (D) with the green pigment combination (A) in the organic solvent (E) using a mixer. The green photosensitive resin composition is coated on a substrate by a spin coating method, a knife coating method, an ink-jet coating method, a roller coating method, or the like, and is then dried under reduced pressure to remove most of the solvent. After completely evaporating the residual solvent by pre-baking, a coating film is formed. The operating conditions for the drying under reduced pressure and the pre-baking depend on kinds and amounts of the components used in the green photosensitive resin composition. In general, the drying under reduced pressure is carried out at a pressure from 0 to 200 mm Hg for a period from 1 to 60 seconds. The pre-baking is carried out at a temperature from 70° C. to 110° C. for a period from 1 to 15 minutes. The coating film, is then exposed to UV light through a specific photo mask, and is developed in a developer solution at a temperature of 23±2° C. for a period from 15 seconds to 5 minutes to dissolve and remove the unexposed portions of the coating film so as to obtain a desired pattern. The substrate with the desired pattern of the coating film is washed with water, is dried with compressed air or compressed nitrogen, and is heated at a temperature from 100°C. to 280° C. for a period of 1 to 15 minutes in a heating device, such as a hot plate or an oven so as to remove evaporative components and to subject the unreacted ethylenically unsaturated compound contained in the coating film to conduct a heat curing reaction. The green filter segment can be obtained thereby. The red and blue filter segments can be obtained using the red and blue photosensitive resin compositions, respectively, following the procedure for making the green filter segment. A color filter with blue, green and red filter segments can be obtained thereby. It is noted that the order of forming blue, green and red filter segments is not limited to the aforementioned procedure.

The UV light used for the exposure of the coating film can be g line, h line, i line, or the like. The UV lamp for providing the UV light is a (ultra)high-pressure mercury lamp or a metal halide lamp. The substrate used to form the color filter is made from bare glass, soda glass, Pyrex glass, silica glass, or anyone of these glass coated with a transparent conductive film, or an electrode substrate (for example, a silicon substrate) used in solid state image pick up devices. A black matrix is formed on the substrate to separate each color pixel element.

Examples of the developer solution include, but are not limited to, an alkali aqueous solution of sodium hydroxide, potassium hydroxide, sodium carbonate, sodium hydrogencarbonate, potassium carbonate, potassium hydrogencarbonate, sodium silicate, sodium methylsilicate, aqueous ammonia, ethylamine, diethylamine, dimethyl ethanolamine, tetramethylammonium hydroxide, tetraethylammonium hydroxide, choline, pyrrole, piperidine, 1,8-diaza-bicyclo(5,4,0)-7-undecene, or the like. The concentration of the developer in the solution is from 0.001 to 10 wt %, preferably from 0.005 to 5 wt. %, and more preferably from 0.01 to 1 wt %.

### Color Liquid Crystal Display Device

A color liquid crystal display device is made by connecting the liquid crystal display element having the color filter with the backlight unit. The method of connecting the liquid crystal display element with the backlight unit is well known and is not a feature of this invention. Therefore, further details are omitted herein for the sake of brevity.

### Liquid Crystal Display Element

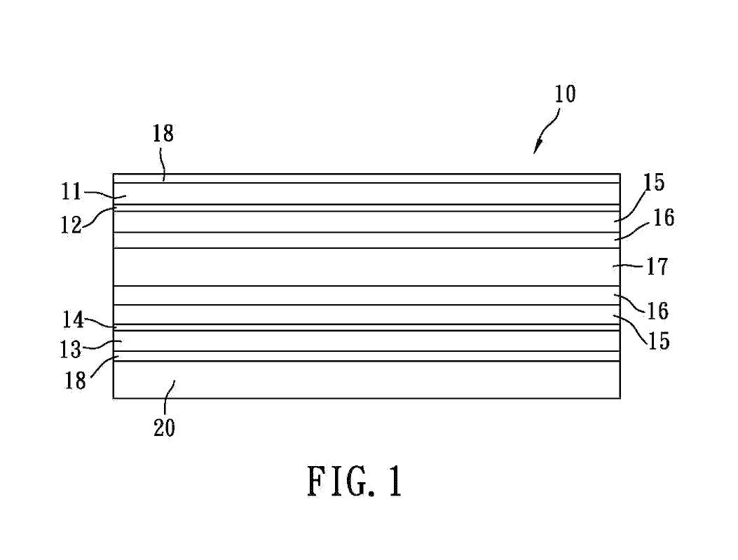

Referring to FIG. 1, the color liquid crystal display device in this invention includes a liquid crystal display element 10 and a backlight unit 20.

The liquid crystal display element 10 in this invention includes a first substrate 11, a color filter 12 formed on a surface of the first substrate 11, a second substrate 13 spaced apart from the color filter 12, a thin-film transistor 14 formed on a surface of the second substrate 13 and spaced apart from the color filter 12, two conducting layers 15 respectively formed on a surface of the color filter 12 and a surface of the thin-film transistor 14, two alignment layers 16 formed respectively on a surfaces of the two conducting layers 15, a liquid crystal layer 17 disposed between the alignment layers 16, and two polarizers 18 respectively coupled to the first and second substrates 11, 13, and distal from the alignment layers 16. The alignment layers 16 are composed of polyimide polymer while the conducting layers 15 are composed of indium tin oxide (abbreviated as ITO). Spacers (not shown) are formed on the alignment layers 16. The conducting layers 15 can be etched and formed with a wiring layout, if necessary. The general configuration of the liquid crystal display device is well known and is not a feature of this invention. Therefore, further details are omitted herein for the sake of brevity.

The liquid crystal layer 17 in this invention can be one using twisted nematic liquid crystal, super twisted nematic liquid crystal, in-plane switching liquid crystal, vertical alignment liquid crystal, optically compensated birefringence liquid crystal, ferroelectric liquid crystal, or the like. The manufacturing process of the liquid crystal display device 10 is well known and is not a feature of this invention. Therefore, further details are omitted herein for the sake of brevity.

### Backlight Unit

The backlight unit 20 is connected to the polarizer 18 of the second substrate 13 of the liquid crystal display element 10, and is capable of emitting light with a color temperature ranging from 8,000 to 20,000 K. Preferably, the backlight unit 20 is selected from a white light emitting diode or a trichrome fluorescent lamp.

### White Light Emitting Diode

In the light-emitting mechanism for the white light emitting diode used as the backlight unit 20, blue light emitted from a light-emitting layer of a light-emitting die is absorbed by photo-luminescent phosphor and is then converted into light of an other color. Some energy is lost during the conversion. When the backlight unit 20 is a white light emitting diode with a color temperature below 8,000 K, the color temperature of the color liquid crystal display device is lowered, which results in deteriorated color reproduction. When the color temperature of the white light emitting diode is above 20,000 K, the color reproduction of the color liquid crystal display device is also inferior.

Preferably, the white light emitting diode having a light emitting layer with a main peak spectrum ranging from 430 nm to 500 nm and a photoluminescent phosphor is used as the backlight unit. The material for the light emitting layer is selected from a nitride compound semiconductor, a group III-V compound semiconductor, a group II-IV compound semiconductor, a group IV-VI compound semiconductor, or combinations thereof. Preferably, the light emitting layer of the blue light emitting die is made of InGaN or GaN material, and is used in combination with the photoluminescent phosphor so as to reach the desired color temperature for the backlight unit.

Specifically, when the white light emitting diode is used as the backlight unit 20, a light-emitting layer of a blue light emitting die is formed with a fluorescence filter film containing the photoluminescent phosphor on a surface thereof, or a package material of the blue light emitting die contains the photoluminescent phosphor. Preferably, the photoluminescent phosphor is selected from yellow phosphor, green phosphor, red phosphor, or combinations thereof.

Preferably, the yellow phosphor is selected from cerium activated aluminum garnet phosphor, europium activated alkaline earth metal silicate phosphor, or a combination thereof. The cerium activated aluminum garnet phosphor is selected from RE₃(Al,Ga)₅O₁₂:Ce, (Tb, Al)₅O₁₂:Ce, or a combination thereof, wherein RE is selected from Y, Gd, La, or combinations thereof. The europium activated alkaline earth metal silicate phosphor is selected from AE₂SiO₄:Eu, Sr₃SiO₅:Eu²⁺, or a combination thereof, wherein AE is selected from Sr, Ba, Ca, or combinations thereof.

Preferably, the green phosphor is selected from cerium activated phosphor, europium activated alkaline earth metal silicate phosphor, or a combination thereof. The cerium activated phosphor is selected from RE₃(Al,Ga)₅O₁₂:Ce, Ca₃So₂O₄:Ce, or a combination thereof, wherein RE is selected from Y, Gd, La, or combinations thereof. The europium activated alkaline earth metal silicate phosphor is selected from AE₂SiO₄:Eu, Ca₃Sc₂Si₃O₁₂:Eu, or combinations thereof, wherein AE is selected from Sr, Ba, Ca, or combinations thereof.

Preferably, the red phosphor is selected from europium activated oxide, europium activated sulfide, europium activated nitride, or combinations thereof. Preferably, the europium activated oxide is Y₂O₃:Eu. The europium activated sulfide is selected from Y₂O₂S:Eu, La₂O₂S:Eu, or a combination thereof. The europium activated nitride is selected from AE₂Si₅N₈:Eu²⁺, CaAlSiN₃:Eu²⁺, CaAlSiBN₃:Eu, or combinations thereof.

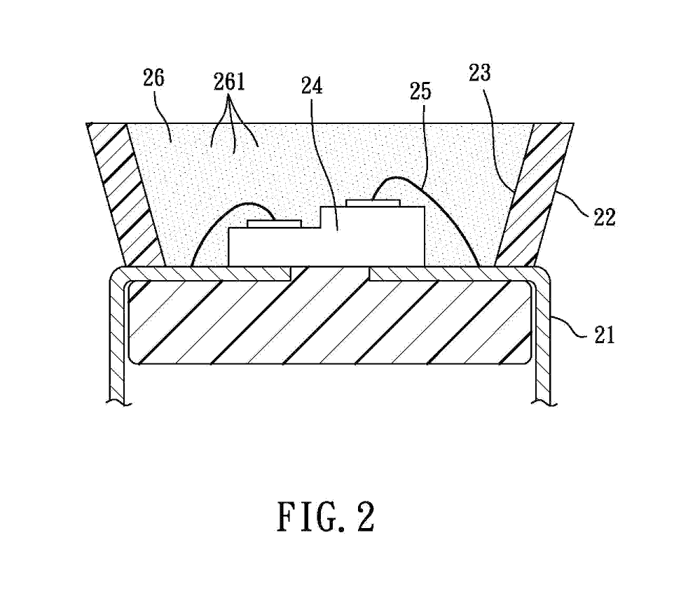

Referring to FIG. 2, the white color light emitting diode includes a lead frame 21, a surrounding wall 22 formed on the lead frame 21, a receiving space 23 defined by the lead frame 21 and the surrounding wall 22, a light emitting die 24 mounted in the receiving space 23 and connected to the lead frame 21, leads 25 for connecting the light emitting die 24 to the lead frame 21, and an encapsulant 26 filled in the receiving space 23 and encapsulating the light emitting die 24. The light emitting die 24 has a main emitting wavelength of 460 nm, and can be electrically connected to external electric circuits through the lead frame 21 and the lead 25. The encapsulant 26 is made from a polysiloxane resin containing photoluminescent phosphor 261 and is heat treated at 70° C. for 3 hours and then at 150° C. for 1 hour so as to be cured.

### Trichrome Fluorescent Lamp

When the trichrome fluorescent lamp with a color temperature lower than 8,000K or higher than 20,000K is used as the backlight unit 20, the color liquid crystal display device suffers from deteriorated color reproduction.

The trichrome fluorescent lamp includes a phosphor combination including a blue phosphor, a green phosphor, and a red phosphor. If the amount of the blue phosphor is increased, the light emitted by the trichrome fluorescent lamp is bluish white, and the color temperature of the backlight unit 20 is increased. If the amount of the red phosphor is increased, the light emitted by the trichrome fluorescent lamp is reddish white, and the color temperature of the backlight unit 20 is decreased. In view of the color temperature, the blue phosphor is selected from Sr₅(PO₄)₃Cl:Eu, (SrCaBa)₅(PO₄)₃Cl:Eu, BaMg₂Al₁₆O₂₇:Eu, or combinations thereof, the green phosphor is selected from LaPO₄:Ce, Tb, (CeTb)MgAl₁₄C₁₉, or a combination thereof, and the red phosphor is Y₂O₃:Eu. Preferably, the blue phosphor is in an amount ranging from 20 to 55 wt %, the green phosphor is in an amount ranging from 20 to 55 wt %, and the red phosphor is in an amount ranging from 20 to 45 wt % based on a total weight of the phosphor combination.

### EXAMPLES

The following examples are provided to illustrate the preferred embodiments of the invention, and should not be construed as limiting the scope of the invention.

### Synthesis Example

### Preparation of Alkali-Soluble Resin

### Synthesis Example 1

A 1000 ml four-necked conical flask equipped with a nitrogen inlet, a stirrer, a heater, a condenser and a thermometer was purged with nitrogen, and was added with 45 parts by weight of 2-methacryloylethoxy succinate, 40 parts by weight of styrene, 15 parts by weight of dicyclopentenyloxyethyl acrylate, and 200 parts by weight of ethyl 3-ethoxypropionate. The ingredients were continuously added into the four-necked conical flask with stirring in an oil bath of 100° C. 4 parts by weight of 2,2″-azobis-2-methyl butyronitrile was dissolved into ethyl 3-ethoxypropionate, divided equally into five portions, and added into the four-necked conical flask portionwise within an hour. Polymerisation was conducted at 100° C. for 6 hours, and a polymerization product was then taken out of the conical flask followed by removal of solvent from the product so as to obtain an alkali-soluble resin (B-1).

### Synthesis Examples 2 and 3

Synthesis Examples 2 and 3 were conducted in a manner identical to that of Synthesis Example 1 with different reaction conditions as well as altered ingredients and amounts which are illustrated in Table 1.

### Preparation Example

### Preparation of Green Photosensitive Resin Composition

### Preparation Example a

100 parts by weight of the alkali-soluble resin (B-1) obtained from Synthesis Example 1, 20 parts by weight of dipentaerythritol hexacrylate (manufactured by Toagosei), 10 parts by weight of 1-[9-ethyl-6-(2-methylbenzoyl)-9H-carbazol-3-yl]-ethylketo 1-(O-acetyloxime), 120 parts by weight of C.I. Pigment Green 07, 80 parts by weight of C.I. Pigment Yellow 138, and 3,000 parts by weight of ethyl 3-ethoxyproptonate were mixed using a shaker to obtain a green photosensitive resin composition.

### Preparation Examples b to j

Preparation Examples b to j were conducted in a manner identical to that of Preparation Example a to prepare green photosensitive resin compositions using the green pigment combination (A), the alkali-soluble resin (B), the compound having at least one ethylenically unsaturated group (C), the photoinitiator (D), and the organic solvent (E) as well as the amounts thereof illustrated in Table 2.

### Preparation Example

### Preparation of Red Photosensitive Resin Composition

### Red-1

160 parts by weight of C.I. Pigment Red 177 , 40 parts by weight of C.I. Pigment Red 166, 20 parts by weight of C.I. Pigment Yellow 150, 100 parts by weight of the alkali-soluble resin (B-1) obtained from Synthesis Example 1, 100 parts by weight of dipentaerythritol hexaacrylate, 8 parts by weight of

1-[9-ethyl-6-(2-methylbenzoyl)-9H-carbazol-3-yl]-ethylketo 1-(O-acetyloxime), 10 parts by weight of 2,2′-bis(2,4-dichlorophenyl)-4,4″,5,5″-tetraphenylbiimidazole, and 2,100 parts by weight of ethyl 3-ethoxypropionate were mixed using a shaker to obtain a red photosensitive resin composition (Red-1).

### Red-2

Preparation of the red photosensitive resin composition (Red-2) was conducted in a manner identical to preparation of the red photosensitive resin composition (Red-1) except that 180 parts by weight of C.I. Pigment Red 254 and 20 parts by weight of C.I. Pigment Red 177 were used.

### Preparation Example

### Preparation of Blue Photosensitive Resin Composition

### Blue-1

99 parts by weight of C.I. Pigment Blue 15:6, 11 parts by weight of C.I. Pigment Violet 23, 100 parts by weight of the alkali-soluble resin (B-1) obtained from Synthesis Example 1, 100 parts by Weight of dipentaerythritol hexaacrylate, 8 parts by weight of 1-[9-ethyl-6-(2-methylbenzoyl)-9H-carbazol-3-yl]-ethylketo 1-(O-acetyloxime), 10 parts by weight of 2,2′-bis(2,4-dichlorophenyl)-4,4′,5,5′-tetraphenylbiimidazole, and 2,100 parts by weight of ethyl 3-ethoxypropionate were mixed using a shaker to obtain a blue photosensitive resin composition (Blue-1).

### Blue-2

Preparation of the blue photosensitive resin composition (Blue-2) was conducted in a manner identical to preparation of the blue photosensitive resin composition (Blue-1) except that 72 parts by weight of C.I. Pigment blue 15:6, 18 parts by weight of C.I. Pigment Violet 23, and 5 parts by weight of C.I. Pigment Green 58 were used.

### <Preparation Example> Preparation of Color Filter

### [Preparation Example 12-a]

The red photosensitive resin composition (Red-1) was spin-coated on a glass substrate, dried under a pressure, of 100 mm Hg for 30 seconds, and pre-baked at a temperature of 80° C. for 3 minutes to form a pre-baked film having a thickness of about 2.5 μm. The pre-baked film was exposed using a mask aligner (Canon PLA-501F, 300 mJ/cm²), was immersed into a developer solution at a temperature of 23° C. for 2 minutes, washed with water, and post-baked at a temperature of 200° C. for 80 minutes to form a red filter segment. The aforesaid procedure was repeated using the green photosensitive resin composition and the blue photosensitive resin composition to form a green filter segment and a blue filter segment. A pixel layer having a thickness of about 2.0 μm was obtained thereby.

An ITO film was deposited on the pixel layer at a temperature of 235° C. under vacuum. The ITO film can be etched and formed with a wiring layout, if necessary. A color filter (12-a) was obtained thereby.

### [Preparation Examples 12-b to 12-k]

Preparation examples 12-b to 12-k were conducted in a manner identical to preparation example 12-a to prepare color filters except that the green photosensitive resin compositions, the red photosensitive resin compositions, and the blue photosensitive resin compositions illustrated in Table 3 were used.

### Preparation Example

### Preparation of Backlight Unit [Preparation Example 20-1-1] White Light Emitting Diode

A blue light-emitting die of InGaN (manufactured by Chi Mei Lighting Technology Corp., light-emitting wavelength of 460 nm) was mounted on a lead frame and was electrically connected to the lead frame using leads. Photoluminescent phosphor in an encapsulant was formed by mixing yellow phosphor of (SrBa)₂SiO₄:Eu with red phosphor of CaAlSiBN₃:Eu. 18 parts by weight of the yellow phosphor and 2.5 parts by weight of the red phosphor were used, based on 100 parts by weight of polysiloxane resin, to obtain a white light emitting diode 20-1-1.

### Preparation Examples 20-1-2 to 20-1-5

Preparation examples 20-1-2 to 20-1-5 were conducted in a manner identical to that of preparation example 20-1-1 to prepare white light emitting diodes except that the types and amounts of the yellow phosphor and the red phosphor illustrated in Table 4 were used.

### [Preparation Examples 20-2-1 ]Trichrome Fluorescent Lamp

Red phosphor of Y₂O₃:Eu, green phosphor of LaPO₄:Ce, Tb, and blue phosphor of (SrCaBa)₅(PO₄)₃Cl:Eu were blended together to form a phosphor blend, which was mixed with a butyl acetate solution of nitrocellulose to obtain a suspension. The suspension vas applied to an inner surface of a glass tube having an inner diameter of 32 mm and was dried to form a coating layer on the inner surface of the glass tube. The coating layer was baked at a temperature of 500° C. to form a trichrome fluorescent lamp (20-2-1) of 40 W.

### Preparation Examples 20-2-2 to 20-2-5

Preparation examples 20-2-2 to 20-2-5 were conducted in a manner identical to that of preparation example 20-2-1 to prepare the trichrome fluorescent lamps except that the types and amounts of thee blue phosphor, the green phosphor, and the red phosphor illustrated in Table 4 were used.

### Example

### Color Liquid Crystal Display Device

### Example 1

The color filter obtained in preparation example 12-a was formed on a first substrate 11, a conducting layer 15 composed of ITO was then formed on the color filter, and an alignment layer 16 composed of polyimide was then formed on the conducting layer 15.

A thin-film transistor 14 was formed on a second substrate 13, a conducting layer 15 composed of ITO was formed on the thin-film transistor 14, and an alignment layer 16 composed of polyimide was formed on the conducting layer 15.

Spacers were applied onto the alignment layer 16. The first substrate 11 and the second substrate 13 were combined together by sealing with a sealant in a manner of leaving a hole for liquid crystal injection. Liquid crystal was injected via the liquid crystal injection hole, followed by sealing the liquid crystal injection hole. Polarizers were attached to the two substrates. A liquid crystal display element was then obtained.

A liquid crystal display device can be produced by combining the aforesaid liquid crystal display element with the backlight unit 20-1-2.

### Examples 2 to 8 and Comparative Examples 1 to 7

Examples 2 to 8 and comparative examples 1 to 7 were conducted in a manner identical to example 1 to prepare the color liquid crystal display devices except that the types of the color filter and the backlight unit illustrated in Table 5 were used.

### Measurements

### 1. Color Temperature of Backlight Unit:

CIE chromaticity coordinate values (x, y) of the backlight units were determined using a colorimeter (manufactured by Otsuka Electronics Co. , Model No. MCPD). Relative color temperatures of backlight units 20-1-1 to 20-1-5 and 20-2-1 to 20-2-5 were determined using chromaticity coordinate values (x, y) and isotemperature line.

### 2. Brightness:

CIE chromaticity coordinate value (x, y) and brightness (Y) of a color liquid crystal display device were determined using a colorimeter (manufactured by Otsuka Electronics Co., Model No. MCPD). The brightness (Y) of green color displayed by the color liquid crystal display device was used, for the brightness evaluation.

### ⊚: Y≦68;

### ◯: 58≧Y<68;

### Δ: 53≦Y<58;

### X: Y<53.

### 3. Color Reproduction:

CIE chromaticity coordinate value of a color liquid crystal display device was determined using the aforesaid colorimeter (manufactured by Otsuka Electronics Co., Model No. MCPD), NTSC ratio can be obtained by dividing color gamut of measured CIE chromaticity coordinates by color gamut of standard CIE chromaticity coordinates. A higher NTSC ratio means better color reproduction.

◯: NTSC ratio≧80%;

### Δ: 70%≦NTSC<80%;

### X: NTSC<70%.

TABLE 1

| | Composition (parts by weight) | | | | | | | | | | | |
|---|---|---|---|---|---|---|---|---|---|---|---|---|
| | | | | | | | | | | | Reaction | Reaction |
| Syn. | Monomers for Copolymerization | | | | | | | Initiator | Solvent | Feeding | Temp. | Time |
| Ex. # | HOMS | MAA | SM | DCPOA | BzMA | PMI | MA | AMBN | EEP | [symbol] | (° C.) | (hrs) |
| B-1 | 45 | — | 40 | 15 | — | — | — | 4 | 200 | Continuous | 100 | 6 |
| B-2 | — | 35 | — | — | 45 | 5 | 15 | 4 | 200 | Continuous | 100 | 6 |
| B-3 | 25 | 20 | 15 | — | 20 | — | 20 | 4 | 200 | Continuous | 100 | 6 |

Note:
HOMS: 2-methacryloylethoxy succinate
MAA: methacrylic acid
SM: styrene monomer
DCPOA: dicyclopentenyloxyethyl acrylate
BzMA: benzyl methacrylate
PMI: N-phenylmaleimide
MA: methyl acrylate
AMBN: 2,2′-azobis-2-methyl butyronitrile
EEP: ethyl 3-ethoxypropionate [symbol]
indicates data missing or illegible when filed

TABLE 2

| Components | | | Preperation Example | | | | | | | | | |
|---|---|---|---|---|---|---|---|---|---|---|---|---|
| Unit: parts by weight | | | a | b | c | d | e | f | g | h | i | j |
| Green | A-1 | C.I. PG 07 | 120 | — | — | — | 56 | 60 | — | — | 100 | 90 |
| Pigment | | C.I. PG 36 | — | 110 | — | — | — | — | 35 | 19 | — | — |
| Combination (A) | | C.I. PG 58 | — | — | 75 | 90 | — | — | — | — | — | — |
| | | C.I. PG 42 | — | — | 30 | — | — | — | — | — | — | — |
| | A-2 | C.I. PY 138 | 80 | — | — | 5 | 11 | — | 5 | — | — | 50 |
| | | C.I. PY 139 | — | 63 | — | — | — | 12 | — | 1 | — | — |
| | | C.I. PY 150 | — | — | 45 | — | — | — | — | — | — | — |
| | | C.I. PY 10 | — | — | — | 25 | — | — | — | — | — | — |
| | A-3 | C.I. PO 13 | — | — | — | — | 30 | — | — | — | — | — |

| Weight ratio (A-1)/(A-2) | | 60/40 | 65/35 | 70/30 | 75/25 | 80/20 | 85/15 | 90/10 | 95/5 | 100/0 | 50/50 |
|---|---|---|---|---|---|---|---|---|---|---|---|
| Weight ratio | | 100/100 | 100/100 | 100/100 | 100/100 | 70/100 | 100/100 | 100/100 | 100/100 | 100/100 | 100/100 |
| [(A-1) + (A-2)]/A | | | | | | | | | | | |
| Alkali-soluble | B-1 | 100 | — | — | 100 | — | — | — | 80 | 100 | 100 |
| resin B | B-2 | — | 100 | — | — | 100 | — | 54 | — | — | — |
| | B-3 | — | — | 100 | — | — | 100 | 54 | 50 | — | — |
| A compoud having at | C-1 | 24 | 50 | 100 | 100 | 200 | 30 | — | 50 | 50 | 54 |
| least one ethylenically | C-2 | — | — | — | — | — | 24 | 50 | | — | — |
| unsaturated group (C) | | | | | | | | | | | |
| Photoinitator | D-1 | 10 | 39 | — | 10 | 20 | 10 | 10 | 19 | 30 | 30 |
| (D) | D-2 | — | — | 25 | 10 | 20 | 5 | 30 | 5 | — | — |
| | D-3 | — | — | 25 | — | — | 14 | 5 | 10 | — | — |
| Solvent (E) | E-1 | 3000 | 2000 | 1000 | 500 | — | 500 | 500 | 500 | 1000 | 2000 |
| | E-2 | — | — | — | — | 1000 | 500 | 500 | 500 | — | — |

Note:
C-1: dipentaerythritol hexaacrylate (manufactured by Toagosei)
C-2: trimethylolpropyl triacrylate
D-1: 1-[9-ethyl-6-(2-methylbenzoly)-9H-carbazol-3-yl]-ethylketo 1-(O-acetyloxime)
D-2: 2,2′-bis(2,4-dichlorophenyl)-4,4′,5,5′-tetraphenylbisimidazole
D-3: 2,4-bis (trichloromethyl)-6-(p-methoxy) styryl-s-triazine
E-1: ethyl 3-ethoxypropionate
E-2: propylene glycol methyl ether acetate

TABLE 3

| | | Green | Red | Blue |
|---|---|---|---|---|
| | | Photosensitive | Photosensitive | Photosensitive |
| | | Resin | Resin | Resin |
| Components | | Composition | Composition | Composition |
| Color | 12-a | Prep. Ex. a | Red-1 | Blue-1 |
| Filter | 12-b | Prep. Ex. b | | |
| Prep. | 12-c | Prep. Ex. c | | |
| Ex. | 12-d | Prep. Ex. d | | |
| | 12-e | Prep. Ex. e | | |
| | 12-f | Prep. Ex. f | | |
| | 12-g | Prep. Ex. g | | |
| | 12-h | Prep. Ex. h | | |
| | 12-i | Prep. Ex. i | | |
| | 12-j | Prep. Ex. j | | |
| | 12-k | Prep. Ex. a | Red-2 | Blue-2 |

TABLE 4

| | | Backlight Unit | | | | | | | | | |
|---|---|---|---|---|---|---|---|---|---|---|---|
| | | White Light Emitting Diode 20-1 | | | | | Trichrome Fluorescent Lamp 20-2 | | | | |
| Prep. Ex. | | 20-1-1 | 20-1-2 | 20-1-3 | 20-1-4 | 20-1-5 | 20-2-1 | 20-2-2 | 20-2-3 | 20-2-4 | 20-2-5 |
| Yellow | Composition | [symbol] | [symbol] | [symbol] | [symbol] | [symbol] | — | — | — | — | — |
| | Amount | [symbol] | 16 | 14.5 | 13.2 | 11 | — | — | — | — | — |
| Red | Composition | [symbol] | [symbol] | [symbol] | [symbol] | [symbol] | [symbol] | | | | |
| | Amount | 2.5 | 2 | 1.5 | 0.9 | 0.5 | 40 | 35 | 33 | 31 | 30 |
| Green | Composition | — | — | — | — | — | [symbol] | | | | |
| | Amount | — | — | — | — | — | 45 | 38 | 33 | 32 | 30 |
| Blue | Composition | — | — | — | — | — | [symbol] | | | | |
| | Amount | — | — | — | — | — | 25 | 31 | 34 | 38 | 40 |

| | | | | | | | | | | |
|---|---|---|---|---|---|---|---|---|---|---|
| Color Temp. (K) | 2,934 | 5,090 | 12,532 | 19,865 | 22,260 | 3,512 | 8,125 | [symbol] | 19,780 | 22,122 |

[symbol]

[symbol]

[symbol]

indicates data missing or illegible when filed

TABLE 5

| | | | | Weight | | | | |
|---|---|---|---|---|---|---|---|---|
| Liquid | | | Weight | ratio | | | Evaluation | |
| Crystal | | | ratio | [(A-1) + | | Color | Items | |
| Display | | Color | (A-1)/ | (A-2)]/ | Backlight | temperature | | Color |
| Device | | Filter | (A-2) | A | unit | (K) | Brightness | reproduction |
| Example | 1 | 12-a | 60/40 | 100/100 | 20-1-2 | 8,090 | ◯ | ◯ |
| | 2 | 12-b | 65/35 | 100/100 | 20-1-3 | 13,532 | ◯ | ◯ |
| | 3 | 12-c | 70/30 | 100/100 | 20-1-4 | 19,805 | ◯ | Δ |
| | 4 | 12-d | 75/25 | 100/100 | 20-2-2 | 8,125 | Δ | ◯ |
| | 5 | 12-e | 80/20 | 70/100 | 20-2-3 | 13,845 | Δ | Δ |
| | 6 | 12-f | 85/15 | 100/100 | 20-2-4 | 19,780 | ◯ | ◯ |
| | 7 | 12-g | 90/10 | 100/100 | 20-1-2 | 8,090 | ◯ | ◯ |
| | 8 | 12-h | 95/5 | 100/100 | 20-2-2 | 8,125 | ◯ | ◯ |
| Comparative | 1 | 12-a | 60/40 | 100/100 | 20-1-1 | 3,934 | ◯ | X |
| Example | 2 | 12-b | 65/35 | 100/100 | 20-1-5 | 22,260 | ◯ | X |
| | 3 | 12-c | 70/30 | 100/100 | 20-2-1 | 3,512 | ◯ | X |
| | 4 | 12-d | 75/25 | 100/100 | 20-2-5 | 22,122 | Δ | X |
| | 5 | 12-i | 100/0 | 100/100 | 20-1-2 | 8,090 | X | ◯ |
| | 6 | 12-j | 50/50 | 100/100 | 20-2-2 | 8,125 | ◯ | X |
| | 7 | 12-k | 60/40 | 100/100 | Illuminant | 6,774 | ◯ | X |
| | | | | | C | | | |

As shown in Table 5, a color liquid crystal display device having better brightness and high color reproduction can be obtained when a weight ratio of the halogenated-phthalocyanine-based green pigment component (A-1) to the yellow pigment component (A-2) is controlled to be within a range from 60/40 to 95/5 and the color temperature of the backlight unit is controlled to be within a range from 8,090 K to 19,805 K.

As for comparative examples 1 to 4, although the weight

ratio of the halogenated-phthalocyanine-based green pigment component (A-1) to the yellow pigment component (A-2) is controlled to be within a range from 60/40 to 75/25, the color temperature of the backlight unit is either lower than 8,000K or higher than 20.000K. The color liquid crystal display devices haves neither high color reproduction nor better brightness.

For comparative examples 5 and 6, although the color temperature of the backlight unit is controlled to be within a range from 8,000 K to 20,000 K, the weight ratios of the halogenated-phthalocyanine-based green pigment component (A-1) to the yellow pigment component (A-2) are 100/0 and 50/50, respectively. The color liquid crystal display devices have neither high color reproduction nor better brightness.

In comparative example 7, a light source C having spectrum and color temperature identical to the spectrum and the color temperature of a cold-cathode fluorescent lamp (CCFL) used in a conventional color liquid crystal display device was used. The conventional color liquid crystal display device is unable to reach color reproduction and brightness obtained by this invention.

In this invention, a color liquid crystal display device having better brightness and high color reproduction can be obtained by controlling the weight ratio of the halogenated-phthalocyanine-based green pigment component (A-1) to the yellow pigment component (A-2) and having a color temperature of a backlight unit to be within a range from 8,000 K to 20,000 K.

While the present invention has been described in connection with what are considered the most practical and preferred embodiments, it is understood, that this invention is not limited to the disclosed embodiments but is intended to cover various arrangements included within the spirit and scope of the broadest interpretation and equivalent arrangements.

What is claimed is:

1. A color liquid crystal display device, comprising:
a liquid crystal display element including a color filter having a blue filter segment, a green filter segment, and a red filter segment, said green filter segment being prepared from a green photosensitive resin composition which includes a pigment combination, an alkali-soluble resin, a compound having at least one ethylenically unsaturated group, and a photoinitiator, said pigment combination including a halogenated-phthalocyanine-based green pigment component and a yellow pigment component, a weight ratio of said halogenated-phthalocyanine-based green pigment component to said yellow pigment component ranging from 60/40 to 95/5; and
a backlight unit coupled to said liquid crystal display element and having a color temperature ranging from 8,000 K to 20,000 K.

2. The color liquid crystal display device as claimed in claim 1, wherein said weight ratio of said halogenated-phthalocyanine-based green pigment component to said yellow pigment component ranges from 65/35 to 90/10.

3. The color liquid crystal display device as claimed in claim 1, wherein said weight ratio of said halogenated-phthalocyanine-based green pigment component to said yellow pigment component ranges from 70/30 to 85/15.

4. The color liquid crystal display device as claimed in claim 1, wherein a total amount of said halogenated-phthalocyanine-based green pigment component and said yellow pigment component is at least 80 wt % based on 100 wt % of said pigment combination.

5. The color liquid crystal display device as claimed in claim 1, wherein said halogenated-phthalocyanine-based green pigment component is selected from the group consisting of C.I. Pigment Green 07, C.I. Pigment Green 36, C.I. Pigment Green 37, C.I. Pigment Green 42, C.I. Pigment Green 58, and combinations thereof.

6. The color liquid crystal display device as claimed in claim 5, wherein a total amount of C.I. Pigment Green 07, C.I. Pigment Green 36, and C.I. Pigment Green 58 is at least 80 wt % based on 100 wt % of said halogenated-phthalocyanine-based green pigment component.

7. The color liquid crystal display device as claimed in claim 1, wherein said yellow pigment component is selected from the group consisting of C.I. Pigment Yellow 1, C.I. Pigment Yellow 3, C.I. Pigment Yellow 10, C.I. Pigment Yellow 12, C.I. Pigment Yellow 13, C.I. Pigment Yellow 14, C.I. Pigment Yellow 17, C.I. Pigment Yellow 20, C.I. 25 Pigment Yellow 24, C.I. Pigment Yellow 31, C.I. Pigment Yellow 55, C.I. Pigment Yellow 81, C.I. Pigment Yellow 83, C.I. Pigment Yellow 93, C.I. Pigment Yellow 94, C.I. Pigment Yellow 97, C.I. Pigment Yellow 109, C.I. Pigment Yellow 110, C.I. Pigment Yellow 128, C.I. Pigment Yellow 138, C.I. Pigment Yellow 139, C.I. Pigment Yellow 150, C.I. Pigment Yellow 153, C.I. Pigment Yellow 154, C.I. Pigment Yellow 155, C.I. Pigment Yellow 166, C.I. Pigment Yellow 167, C.I. Pigment Yellow 168, C.I. Pigment Yellow 180, C.I. Pigment Yellow 185, C.I. Pigment Yellow 21.1, C.I. Pigment Yellow 219, and combinations, thereof.

8. The color liquid crystal display device as claimed in claim 7, wherein a total amount of C.I. Pigment Yellow 138, C.I. Pigment Yellow 139, and C.I. Pigment Yellow 1.50 is at least 20 wt % based on 100 wt % of said yellow pigment component.

9. The color liquid crystal display device as claimed in claim 1, wherein said backlight unit is selected from the group consisting of a white light emitting diode, a trichrome fluorescent lamp, and a combination thereof.

10. The color liquid crystal display device as claimed in claim 9, wherein said backlight unit is said white light emitting diode including a light emitting layer having a main peak of luminescent spectrum ranging from 430 nm to 500 nm, and a photoluminescent phosphor, said light emitting layer being made of a material selected from the group consisting of a nitride compound semiconductor, a group III-V compound semiconductor, a group II-IV compound semiconductor, a group TV-VT compound semiconductor, and combinations thereof.

11. The color liquid crystal display device as claimed in claim 10, wherein said photoluminescent phosphor is selected from the group consisting of a yellow phosphor, a green phosphor, a red phosphor, and combinations thereof.

12. The color liquid crystal display device as claimed in claim 11, wherein said yellow phosphor is selected from the group consisting of a cerium activated aluminum garnet phosphor, a europium activated alkaline earth metal silicate phosphor, and a combination thereof, said cerium activated aluminum garnet phosphor being selected from the group consisting of a phosphor of RE₃(Al,Ga)₅O₁₂:Ce, a phosphor of (Tb,Al)₅O₁₂:Ce, and a combination thereof, wherein RE is selected from the group consisting of Y, Gd, La, and combinations thereof, said europium activated alkaline earth metal silicate phosphor being selected from the group consisting of a phosphor of AE₂SiO₄:Eu, a phosphor of Sr₃SiO₅:Eu²⁺, and a combination thereof, wherein AE is selected from the group consisting of Sr, Ba, Ca, and combinations thereof.

13. The color liquid crystal display device as claimed in claim 11, wherein said green phosphor is selected from the group consisting of a cerium activated aluminum garnet phosphor, a europium activated alkaline earth metal silicate phosphor, and a combination thereof, said cerium activated aluminum garnet phosphor being selected from the group consisting of a phosphor of RE₃(Al,Ga)₅O₁₂:Ce, a phosphor of Ca₃Sc₂O₄:Ce, and a combination thereof, wherein RE is selected from the group consisting of Y, Gd, La, and combinations thereof, said europium activated alkaline earth metal silicate phosphor being selected from the group consisting of a phosphor of AE₂SiO₄:Eu, a phosphor of Ca₃Sc₂Si₃O₁₂:Eu, and a combination thereof, wherein AE is selected from the group consisting of Sr, Ba, Ca, and combinations thereof.

14. The color liquid crystal display device as claimed in claim 11, wherein said red phosphor is selected from the group consisting of a europium activated oxide phosphor a europium activated sulfide phosphor, a europium activated nitride phosphor, and combinations thereof.

15. The color liquid crystal display device as claimed in claim 14, wherein said europium activated oxide phosphor is Y₂O₃:Eu, said europium activated sulfide phosphor being selected from the group consisting of Y₂O₂S:Eu, La₂O₂S:Eu, and a combination thereof, said europium activated nitride phosphor being selected from the group consisting of AE₂Si₅N₈:Eu²⁺, CaAlSiN₃:Eu²⁺, CaAlSiBN₃:Eu, and combinations thereof, wherein AE is selected from the group consisting of Sr, Ba, Ca, and combinations thereof.

16. The color liquid crystal display device as claimed in claim 9, wherein said backlight unit is said trichrome fluorescent lamp which includes a blue phosphor, a green phosphor, and a red phosphor.

17. The color liquid crystal display device as claimed in claim 16, wherein said blue phosphor is selected, from the group consisting of Sr₅(PO₄)₃Cl:Eu, (SrCaBa )₅(PO₄)₃Cl:Eu, BaMg₂Al₁₆O₂₇:Eu, and combinations thereof, said green phosphor is selected from the group consisting of LaPO₄:Ce,Tb, (CeTb)MgAl₁₄O₁₉, and a combination thereof, and said red phosphor is Y₂O₃:Eu.

18. The color liquid crystal display device as claimed in claim 16, wherein said blue phosphor is in an amount ranging from 20 to 55 wt %, said green phosphor is in an amount ranging from 20 to 55 wt %, and said red phosphor is in an amount ranging from 20 to 45 wt % based on 100 wt % of total amount of said blue, green and red phosphors.
